(19) United States
(12) Patent Application Publication
(10) Pub. No.: US 2019/0093637 A1
(43) Pub. Date: Mar. 28, 2019

(54) HEAVY-DUTY UPGRADING METHOD FOR ROTOR BLADES OF EXISTING WIND TURBINES

(71) Applicant: INNOGY SE, Essen (DE)

(72) Inventors: Jan-Bernd Franke, Elmshorn (DE); Daniel Bartminn, Elmshorn (DE)

(73) Assignee: INNOGY SE, Essen (DE)

(21) Appl. No.: 16/094,743

(22) PCT Filed: Apr. 20, 2017
(86) PCT No.: PCT/EP2017/059372

§ 371 Date: Oct. 18, 2018

(30) Foreign Application Priority Data
Apr. 20, 2016 (DE) 10 2016 206 661.7

(51) Int. Cl. F03D 80/50; F03D 1/06; B29C 63/00; B29C 63/18; B29C 63/22; B29C 73/04

(52) U.S. Cl. CPC F03D 80/50; F03D 1/0675; B29C 63/0021; B29C 63/0073; B29L 2031/085; B29C 63/22; B29C 73/04; F05B 2240/30; B29C 63/18

(57) ABSTRACT

The invention relates to a heavy-duty upgrading method for rotor blades of existing wind turbines and to a plastic membrane used in the method according to the invention, wherein the rotor blades are covered and/or extended in that at least one fibre-reinforced or fabric-reinforced plastic membrane is fitted onto an outer surface of the original aerodynamic profile of the rotor blade being upgraded and the original contour of the rotor blade being upgraded is then joined to the upgraded rotor blade.

### RELATED APPLICATIONS

This Application is a § 371 National Stage Application of PCT/EP2017/059372, filed Apr. 20, 2017, which claims priority benefit of German Patent Application No. 102016206661.7, filed Apr. 20, 2016, which applications are incorporated entirely by reference herein for all purposes.

### FIELD

The invention relates to a method for strengthening rotor blades of existing wind turbines.

The invention additionally relates to a plastic membrane for use in the method according to the invention.

### BACKGROUND ART

Wind turbines normally comprise a tower structure, a nacelle that is arranged so as to be rotatable on the tower structure and that carries a generator, and a rotor, comprising a plurality of rotor blades, which is flange-connected to a rotor shaft of the generator.

Such rotor blades are components subjected to high structural loading, which are normally composed of glass-fiber reinforced plastic. Upon each revolution rotor blades are subjected to bending to a greater or lesser extent, which entails a certain fatiguing of the material over the service life.

Moreover, external influences occasionally cause damage to the rotor blade that can result in weakening of the structure of the rotor blade, to the extent of total structural failure.

It is known in principle to repair relatively minor damage to rotor blades during the course of normal servicing work. This is normally effected by laminating-on or bonding-on glass-fiber mats or similar sheet elements. Frequently, repairs are effected by building up the rotor blade in layers at the damaged location.

Numerous measures are known for constructionally increasing the structural strength of rotor blades. At present, rotor blades are produced almost exclusively by hand. This results in a certain fluctuation in the production quality, which entail differing load capacities of rotor blades. Newer rotor blades are made in part from carbon fibers, instead of glass fibers.

Many wind turbines having so-called first-generation rotor blades, which are made of glass-fiber reinforced plastic, will accordingly reach the end of their structural and licensed service life.

In principle, therefore, there is the need to provide a structural reinforcement of rotor blades by which an extension of the service life of existing wind turbines can be achieved.

### SUMMARY OF THE INVENTION

The invention is therefore based on the object of providing a method for reinforcing rotor blades of existing wind turbines.

The invention is furthermore based on the object of providing a material for the retrofitting of structural strengthening of rotor blades of existing wind turbines.

The object is achieved by a method for strengthening rotor blades of existing wind turbines, comprising the cladding and/or extension of the profile of at least one rotor blade to be strengthened, wherein the cladding and/or extension is effected in that at least one fiber-reinforced or fabric-reinforced plastic membrane is matched to a shell surface of the original aerodynamic profile of the rotor blade to be strengthened and, following the original contour of the rotor blade to be strengthened, is connected to the rotor blade to be strengthened.

### DETAILED DESCRIPTION OF THE EMBODIMENTS

Such a method has the advantage, not only that the structure of an existing rotor blade can be reinforced relatively easily, but that the overall rotor blade length can thus also be increased. The power yield of the rotor blade increases with the square of the rotor diameter.

This advantage of the method according to the invention also takes account of the fact that, latterly, existing operating experience with wind turbines has provided better knowledge about possible load reserves of the mechanical system parts and of the supporting structure.

It is provided by the method according to the invention to wholly or partially wrap or clad the rotor blade to be strengthened, the fiber-reinforced or fabric-reinforced plastic membrane used therein for the rotor blade to be strengthened being fabricated such that the aerodynamic profile of the rotor blade to be strengthened is reproduced as closely as possible.

The cladding and/or extension of the rotor blade to be strengthened is preferably effected such that the original structure of the rotor blade to be strengthened is prevented from breaking apart.

In an expedient variant of the method it is provided that the plastic membrane is connected in a materially bonded manner to the rotor blade to be strengthened. For example, this plastic membrane may be connected to the rotor blade to be strengthened by means of a bonding agent, for example by means of an adhesive or a cement.

Alternatively, the plastic membrane may be shrunk onto the rotor blade to be strengthened.

The method comprises the prefabrication of the plastic membrane as an element matched to the original aerodynamic profile of the rotor blade to be strengthened.

The plastic membrane may be wholly or partially packed with a bonding agent or a cement, for example in the form of a grouting compound, on the rotor blade to be strengthened, i.e. in situ.

The plastic membrane may be realized as a circumferentially closed sock or tube, and drawn on, over a rotor-blade tip of the rotor blade to be strengthened, onto the rotor blade to be strengthened. A sock within the meaning of the present invention is to be understood to mean an entity that is drawn on or threaded over the rotor-blade tip, the sock being closed at its end that faces toward the rotor-blade tip. Alternatively, the plastic membrane may be realized as a tube that is open at both ends. The sock or tube may in each case be fastened by clamping, tacking, adhesive bonding, shrinking or welding.

In principle, it may be provided to completely or partially clad the rotor blade to be strengthened with the plastic membrane. “Completely” in this sense is to be understood to mean a complete cladding from the rotor-blade tip to a rotor-blade root; “partially” within the meaning of the invention is to be understood to mean cladding of a longitudinal portion of the rotor blade to be strengthened with the plastic membrane. In each case it is provided that the plastic membrane completely encompasses the circumference of the rotor blade to be strengthened.

In a particularly advantageous variant of the method according to the invention, it may be provided that aerodynamically active flow elements are formed onto or fastened to the plastic membrane. Ideally, the aerodynamically active flow elements are formed onto the plastic membrane during the manufacture thereof. For example, spoilers, so-called winglets or fences may be provided as aerodynamic flow elements, which may be securely fastened to the rotor blade structure, for example in the rotor-blade root region, by means of the plastic membrane.

Operating practice with existing wind turbines has shown that aerodynamically active ancillary component parts, or aerodynamically active flow elements, that are retroactively adhesive-bonded to the rotor blade do not adhere permanently to the rotor blade.

In addition, lightning receptors and/or lightning deflectors may be fastened to the exterior of the rotor blade by means of the plastic membrane used in the method according to the invention. In a particularly preferred method of the method according to the invention, it is provided that injection channels for a grouting compound are provided in the plastic membrane, and via the injection channels a grouting compound is inserted, as a filling compound and/or bonding agent, into a space between a shell surface of the rotor blade to be strengthened and the plastic membrane. The injection channels can be realized such that outlet openings for the grouting compound are provided at those locations on the inside of the plastic membrane at which a selective thickening of the shell surface of the rotor blade or compensation of irregularities in the shell surface of the rotor blade to be strengthened is to be achieved.

Preferably, the plastic membrane is realized as a technical fabric or scrim that is coated or impregnated with plastic, and that comprises fibers selected from a group comprising glass fibers, PVC fibers, PTFE fibers, carbon fibers, polyester fibers, and combinations of the aforementioned materials.

Such plastic membranes are also known as so-called “structural membranes”. They may be realized so as to flexible to a greater or lesser degree, the fiber structure of the plastic membrane imparting a corresponding tensile strength.

As already mentioned above, the fiber reinforcement of the plastic membrane may be realized in the form of a fabric having weft and warp threads. By contrast, in the case of a scrim of fibers that is an alternative possibility, the fibers are not woven together in the sense of a conventional fabric, but are only laid in layers with intersecting directions of pull.

The object on which the invention is based is furthermore achieved by a plastic membrane for use in the method according to the invention, the plastic membrane being realized as a sock or tube, of a reinforcing fabric or scrim of high-tensile fibers, that is matched to the contour of the rotor blade to be strengthened, and that is coated with a polymer or embedded in a polymer matrix.

The plastic membrane may have formed on or formed in injection channels for a grouting compound. The injection channels, or also injection tubes, may be of differing lengths and have outlet openings on the inside, on differing portions of the plastic membrane.

Alternatively or additionally, aerodynamically active elements, for example in the form of spoilers, winglets or fences, may be fastened to the plastic membrane. Furthermore, lightning deflectors, lightning receptors or the like may be fastened in the plastic membrane.

The plastic membrane may be realized so as to be at least partially of a self-supporting stiffness. For example, the plastic membrane may be realized so as to be flexible in portions and stiff in portions.

In a variant of the plastic membrane according to the invention, in which it is realized as a sock, the plastic membrane may have a dimensionally stable, rigid cap, which reproduces the shape of a rotor-blade tip. A rotor-blade extension is thereby achieved. Since the rotor-blade tip is subjected to greater structural loading, it is expedient for it to be made as rigid as possible.

A further aspect of the invention relates to a strengthened rotor blade for a wind turbine having an (original) aerodynamic profile, comprising a cladding and/or extension of the aerodynamic profile, as a strengthening measure, in the form of at least one fiber-reinforced or fabric-reinforced plastic membrane, which is matched to the shell surface of the aerodynamic profile and, following the original contour of the rotor blade, is connected to the rotor blade.

The strengthened rotor blade preferably has at least one plastic membrane, which has one or more of the features of the plastic membrane described above.

1. A method for strengthening rotor blades of existing wind turbines, comprising a cladding and/or extension of a profile of at least one rotor blade to be strengthened, wherein the cladding and/or extension is effected in that at least one fiber-reinforced or fabric-reinforced plastic membrane is matched to a shell surface of an original aerodynamic profile of the rotor blade to be strengthened and, following the original contour of the rotor blade to be strengthened, is connected to the rotor blade to be strengthened.

2. The method as claimed in claim 1, characterized in that the plastic membrane is connected in a materially bonded manner to the rotor blade to be strengthened.

3. The method as claimed in claim 1, characterized in that the plastic membrane is prefabricated as an element matched to the original aerodynamic profile of the rotor blade to be strengthened.

4. The method as claimed in claim 1, characterized in that the plastic membrane is packed with a bonding agent or a cement on the rotor blade to be strengthened.

5. The method as claimed in claim 1, characterized in that the plastic membrane is configured as a circumferentially closed sock or tube, and drawn on, over a rotor-blade tip of the rotor blade to be strengthened, onto the rotor blade to be strengthened.

6. The method as claimed in claim 1, characterized in that the rotor blade to be strengthened is completely or partially clad with the plastic membrane.

7. The method as claimed in claim 1, characterized in that aerodynamically active flow elements are formed onto the plastic membrane.

8. The method as claimed in claim 1, characterized in that injection channels for a grouting compound are provided in the plastic membrane, and via the injection channels a grouting compound is inserted, as a filling compound and/or bonding agent, into a space between a shell surface of the rotor blade to be strengthened and the plastic membrane.

9. The method as claimed in claim 1, characterized in that the plastic membrane is configured as a technical fabric or scrim that is coated or impregnated with plastic, and that comprises fibers selected from a group comprising glass fibers, PVC fibers, PTFE fibers, carbon fibers, polyester fibers, and combinations of the aforementioned materials.

10. A plastic membrane for strengthening rotor blades of existing wind turbines, configured as a sock or tube, comprising a reinforcing fabric or scrim of high-tensile fibers, that is matched to the contour of the rotor blade to be strengthened, and that is coated with a polymer or embedded in a polymer matrix.

11. The plastic membrane as claimed in claim 10, characterized in that it has formed on or formed in injection channels for a grouting compound.

12. The plastic membrane as claimed in claim 10, to which aerodynamically active flow elements are fastened.

13. The plastic membrane as claimed in claim 10, characterized to be at least partially of a self-supporting stiffness.

14. The plastic membrane as claimed in claim 10, configured as a sock, which has a dimensionally stable, rigid cap.

15. A strengthened rotor blade for a wind turbine comprising an aerodynamic profile, comprising a cladding and/or extension of the aerodynamic profile, configured as a strengthening measure, in the form of at least one fiber-reinforced or fabric-reinforced plastic membrane, which is matched to the shell surface of the aerodynamic profile and, following the original contour of the rotor blade, is connected to the rotor blade.

16. The strengthened rotor blade as claimed in claim 15, wherein the plastic membrane is configured as a sock or tube, comprising a reinforcing fabric or scrim of high-tensile fibers, that is matched to the contour of the strengthened rotor blade, and that is coated with a polymer or embedded in a polymer matrix.

17. The strengthened rotor blade as claimed in claim 15, wherein the plastic membrane has formed on or formed in injection channels for a grouting compound.

18. The strengthened rotor blade as claimed in claim 15, wherein aerodynamically active flow elements are fastened to the plastic membrane.

19. The strengthened rotor blade as claimed in claim 15, wherein the plastic membrane is configured to be at least partially of a self-supporting stiffness.

20. The strengthened rotor blade as claimed in claim 15, wherein the plastic membrane comprises a dimensionally stable, rigid cap.
